(19) United States
(12) Patent Application Publication
(10) Pub. No.: US 2008/0232694 A1
(43) Pub. Date: Sep. 25, 2008

(54) FAST IMAGING DATA CLASSIFICATION METHOD AND APPARATUS

(76) Inventor: Peter Sulatycke, Arlington Heights, IL (US)

Correspondence Address: FITCH EVEN TABIN AND FLANNERY;VARIAN MEDICAL SYSTEMS, 120 SOUTH LASALLE STREET, SUITE 1600, CHICAGO, IL, 60603, US

(21) Appl. No.: 11/864,212

(22) Filed: Sep. 28, 2007

Related U.S. Application Data
(60) Provisional application No. 60/896,022, filed on Mar. 21, 2007.
(60) Provisional application No. 60/896,030, filed on Mar. 21, 2007.

(51) Int. Cl. G06K 9/62

(52) U.S. Cl. 382/224

(57) ABSTRACT

Image data is acquired, and a comparator circuit or similar structure determines the status of a value of at least one value type of the image data with respect to at least one predetermined range of valid values for the value type. Then, the image data is defined as a function of the status of the image data with respect to the at least one predetermined range of valid values. The image data that falls within the predetermined range(s) of valid values may then be passed for further processing to contribute to a displayed image. Image data that is defined as invalid is typically then removed from the image rendering process to conserve processing and memory resources.

### RELATED APPLICATIONS

This application claims the benefit of U.S. Provisional Application No. 60/896,022, filed Mar. 21, 2007, and U.S. Provisional Application No. 60/896,030, filed Mar. 21, 2007, the contents of each of which are fully incorporated herein by this reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Grant No. 2R44RR019787-02 awarded by NIH.

### TECHNICAL FIELD

This invention relates generally to processing data for imaging systems.

### BACKGROUND

Modern scientific applications generate very large three-dimensional data sets, also commonly referred to as volume data. Volume data either is generated from imaging systems that sample a three-dimensional (3D) object or produced through computer simulations. Each of these sources produces a three-dimensional grid of sample values that represent the properties inside a three-dimensional real or simulated object. The size of this data (from tens of Megabytes to Gigabytes) requires it to be visualized with computers to be fully understood. The volume data is “reconstructed” through the use of computer graphic techniques to produce images that represent various structures within the object. This ability to model interior structures provides an extremely valuable diagnostic and exploratory capability in a variety of fields. The main stumbling blocks to providing meaningful visualizations of volume data is the enormous amount of computations and bandwidth that are required. As a result, numerous acceleration techniques have been proposed to accelerate the visualization of volume data.

Volume Data Sources

One of the better known fields where three-dimensional sampling systems are employed is in the medical imaging field. A variety of three-dimensional sampling systems are used in this field, including: computer axial tomography (CAT), nuclear magnetic resonance (NMR), ultrasound scanning, positron emission tomography (PET), emission computer tomography (ECT), multimodality imaging (MMI), and X-ray scanning. All of these techniques produce a regular three-dimensional grid of sample values that represent the properties inside a three-dimensional object. In medical imaging, the three-dimensional object is typically a human body or part of it. Examples of the physical properties measured at regular three-dimensional positions include the coefficient of X-ray absorption in the CAT case or the spin-spin or the spin-lattice relaxation parameters in the case of NMR imaging. In all these cases, the measured values reflect variations in the composition, density, or structural characteristics of the underlying physical objects, thus providing knowledge about internal structures that can be used for diagnostic and exploratory purposes. This capability is invaluable in today's modern medicine.

Another example of a field that commonly uses modern sampling to produce large volume data is in the oil industry. The oil industry commonly uses three-dimensional acoustic sampling to attain information about geologic structures within the earth. Just as in medical imaging systems, the resulting volume data is used to visualize interior structures. This information helps scientists to locate new oil sources more quickly and cheaply. In addition, volume data collected over time aids scientists in maintaining current oil reservoirs, prolonging the life of a reservoir, and thus saving money.

Another method for producing volume data is through computer synthesis/generation techniques. One way to synthesize volume data is through the use of finite element computations. Example applications include: fluid dynamics, climate modeling, airfoil analysis, mechanical stress analysis, and electro-magnetic analysis just to name a few. The volume data may be produced on various types of three-dimensional grids, including rectilinear, curvilinear, and unstructured grids, for example. These applications typically produce a plurality of data values at each grid point thereby producing huge amounts of volume data that must be visualized to be understood. These data values represent separate physical properties of the object being investigated. Example properties include: density, velocity, acceleration, temperature, and pressure just to name a few. Because each calculated property is present at every grid point, each property data set can be considered a separate volume data set.

Each sampled or synthesized data value is associated with a specific array index position in a grid within the volume under study. The set of adjacent data values that form polyhedra within the volume data set form what is known in the art as voxels. For example, when the grid is in the shape of equidistant parallel planes, eight neighboring data values form voxels in the shape of cubes. In other types of grids, neighboring data values may form voxels with different polyhedron shapes. For example, curvilinear grids used in computational fluid dynamics are often broken down into finer grids made up of voxels in the shape of tetrahedron. Graphic modeling and display is then performed on the tetrahedron shaped voxels. Regardless of which voxel type is being used, voxels are the fundamental structure used in the rendering of volume data because they provide the finest level of detail.

Types of Volume Rendering Systems

It is known how to utilize the above types of volume data to generate visual images of the volume data's interior structures on a display system. Volume rendering systems typically fall into two general categories: surface rendering and direct volume rendering. Either type of system can be used to display two-dimensional (2D) images of 3D volume interior structures.

In the art, direct rendering systems were developed as an alternative to surface rendering's reliance on graphics accelerators. These systems are so named because they do not produce any intermediate surface representation but instead directly produce a fully rendered raster image as output. This direct control over the complete rendering process gives direct rendering systems the distinct advantage of producing more accurate images if desired. This is accomplished by modeling continuous surfaces within the volume instead of one discrete surface. By adding together, in different proportions, discrete surfaces produced over a range of property values, a more accurate composite image can be produced. On the down side, direct rendering systems must recalculate and re-render the complete surface for images from different viewpoints. This fact, in combination with no direct hardware support, can make direct rendering a very slow process. Thus, there has been a strong need for techniques to accelerate volume rendering.

Types of Direct Volume Rendering Systems

Volume rendering algorithms are usually classified according to how they traverse the volume to be processed in the image plane. The three main classes of volume rendering systems are image-order, object-order, and hybrid. Image-order algorithms loop over each of the pixels in the image plane while object-order algorithms loop over the volume. Hybrid techniques consist of some combination of image-order and object-order techniques.

A prime example of image-order volume rendering is the raycasting algorithm. For each pixel in the viewplane, raycasting sends a ray from the pixel into the volume. The ray is resampled at equidistant sample locations and each sample is assigned an opacity and a color through a classification process. Gradients and shading of the samples are then calculated. Lastly, the colors of each sample are composited together to form the color of the pixel value. The opacity values act as weights so that some samples are more represented in the final pixel value than other samples. In fact, most samples do not contribute any color to the final pixel value.

The most often cited object-order volume rendering is splatting. Every voxel within the volume is visited and assigned a color and an opacity based on the classification process. The classified voxel is then projected onto the viewplane with a Gaussian shape. The projection typically covers many pixels. For each covered pixel the color and opacity contribution from the voxel is calculated. Pixels closer to the center of the Gaussian projection will have higher contributions. The color and opacity contributions are then composited into the accumulated color and opacity at each covered pixel. The projections can be thought of as snowballs or paint balls that have been splatted onto a wall.

One known hybrid volume rendering technique is the shear-warp technique. This technique has characteristics of both image-order and object-order algorithms. As in object-order algorithms, the data within the volume is traversed. Instead of projecting the voxels onto on the viewplane, however, samples are calculated within each group of four voxels in a slice and assigned to a predetermined pixel. Opacity and color assignments are performed as in ray tracing. Shear-warp has advantages of object-order algorithms (in-order data access) and image-order algorithms (early ray termination).

Volume Rendering Acceleration Techniques

Numerous techniques have been developed to accelerate direct volume rendering. The dominant volume rendering characteristic utilized by acceleration algorithms is that only a small fraction (1-10%) of the volume actually contributes to the final rendered image. This is due to two volume rendering traits: 1) some of the volume is empty and 2) many of the voxels will have a derived opacity value of zero. The goal of these acceleration algorithms is to quickly find the voxels that are not empty and will not have an opacity of zero. In the art, these voxels are typically called the “voxels of interest”. Only the voxels of interest actually need to be rendered. Finding the voxels of interest is complicated because the voxels with non-zero opacity change when the classification function changes.

Software-based image-order systems (i.e., raycasting) running on standard central processing units (CPUs) are accelerated by not processing the samples that turn out to have an opacity below a predetermined value (typically zero). For samples with an opacity of zero, this simple comparison can avoid the calculations that go after classification, such as gradients, shading, and compositing. Hardware-based systems typically have not been able to gain a similar acceleration with this technique because no useful work can easily be done in place of the skipped calculations. This is due to the pipeline design used in hardware implementations. A second complication for a hardware implementation is that opacity calculations are performed using classification lookup tables that require a significant amount of memory. This can become especially problematic in systems that require multiple samples or voxels to be tested simultaneously, for example, in a hardware based volume renderer that uses multiple rendering pipelines. Lastly, lookup tables are especially inefficient in single instruction multiple data (SIMD)-based computer systems because vector-based commands cannot be used with lookup tables. For example, in the Cell processor developed for the Playstation3, each lookup operation must be performed sequentially and followed by a shift. This takes significantly more computer cycles than one vector operation would. Thus, it would be advantageous to provide a method to quickly determine if a sample has a valid opacity value without using classification lookup tables and without using large amounts of memory. This would allow hardware-based and SIMD-based image-order volume rendering systems to take advantage of this second trait for acceleration purposes.

Like image-order volume rendering systems, object-order systems (i.e., splatting) can also take advantage of these traits. Instead of evaluating samples, however, voxels are evaluated. For example, the opacity and color of each voxel is first calculated during the classification process. If the opacity value is below a threshold (typically zero) the voxel is not projected and reconstructed across multiple pixels. Instead, processing of the voxel is stopped, and processing of the next voxel takes place. As in image-order systems, the use of lookup tables makes this technique difficult to use in hardware-based systems and SIMD-based systems. Thus, it would be advantageous to provide a method to quickly determine if a voxel has a valid opacity value without using classification lookup tables and without using large amounts of memory. This would allow hardware-based and SIMD-based, object-order volume rendering systems to take advantage of this second trait for acceleration purposes.

Researchers have extended the previously described algorithms that find samples and voxels of interest to finding the groups of samples and voxels that are of interest. Example techniques include algorithms based on: hierarchical spatial data structures, value sorted data structures, and “space leaping” data structures.

Algorithms based on space leaping data structures are common techniques used to find groups of voxels of interest with image-order (raycasting) systems. These techniques work by pre-classifying the whole volume for a particular classification function. A distance data structure is then created that calculates for each voxel the distance to the next voxel that has an opacity greater than a predetermined value (i.e., zero). The distance data structure is then used in normal raycasting to skip over the voxels that have an opacity of zero. This effectively allows the raycasting system to avoid processing many of the voxels that would not contribute to the final image. The main downside to these techniques is that they only work on preclassified volumes. Whenever the classification function changes, the preprocessing required for the distance transforms must be recalculated. This makes this technique only viable when the classification function is fixed. Thus, it would be advantageous to provide a method to quickly determine if a group of voxels has valid opacity values when the classification function and viewpoint is changing dynamically. It would also be advantageous if this method did not require preprocessing and additional storage.

A popular method of finding groups of voxels of interest with object-order systems (i.e., splatting) includes algorithms based on value sorted data structures. In these algorithms, part of the volume (i.e., slice) is sorted by the data value stored at each voxel. This sorting causes the implicit spatial information of the volume to be lost. Thus, the spatial coordinates of each voxel must now be stored with each sorted voxel. The user then gives a range of data values to be volume rendered. All of the voxels within this range are found by binary searching the sorted list of voxels. An advantage of this technique is that it not only works for changes in viewpoint but also for changes in classification functions. This technique, however, requires a significant amount of extra storage because voxel locations must be stored explicitly and because the volume must be stored multiple times. Lastly, this technique cannot be used for image-order volume rendering algorithms like raytracing because such algorithms need immediate access to their neighboring voxels. Thus, it would be advantageous to provide a method that accelerates volume rendering when viewpoints and classification functions change in real-time without having to store all voxel locations explicitly.

Another popular technique for accelerating volume rendering is the use of spatial data structures. Spatial data structures such as octrees and k-trees have been used to accelerate both image-order and object-order acceleration algorithms. These algorithms typically leave the original volume intact while adding an auxiliary data structure that hierarchically organizes the volume by its contained data values. The majority of such algorithms do not organize the volume by its data values but by the voxel's opacities that have been precalculated for a particular classification function. These approaches cannot be used to accelerate volume rendering when the classification function changes in real-time.

Octrees have also been used to accelerate hybrid volume rendering systems. Octrees are a data tree structure that contains eight children at each node, each child representing a smaller spatial subdivision of the volume. Each node contains the range of data values that are represented by the children that are below it. Node traversal ends when a node represents a predetermined minimum spatial size or all of the data values within the spatial area represented by the node are equal. Unlike most other volume rendering octree-based techniques, the octree used in the shear warp system contains voxel data values, not preclassified opacity values. As the octree is traversed, the opacities of the range of voxels at each node are determined. If the opacities are found to be above a predetermined value (i.e., zero), the octree would be further descended. If the opacities are below or equal to the predetermined value, however, the octree would not be further descended from that node. This allows the system to quickly find the voxels of interest without processing too many voxels not of interest. This acceleration method also works for both dynamic changes in viewpoint and classification tables because the method uses summed area tables to quickly determine the opacity values for a range of voxel values. The primary disadvantages of this technique are that the summed area table needs to be recreated for each new classification function, it requires additional memory, and it becomes less practical when higher order classification functions are used. Thus, it would be advantageous to provide a method that quickly determines if a range of voxels contain valid opacities without requiring preprocessing for each change in the classification function. Furthermore, it would be advantageous whether this method worked equally well with multi-dimensional classification transfer functions.

Another known splatting-based volume rendering system and method uses an octree to spatially organize a volume's data values without using a summed area table to determine how the octree should be processed. Instead, if the min-max value of a node does not overlap the voxels of interest, the function skips the node, but the method of determining the voxels of interest is unknown. In addition, the method does not show how more complicated classification functions such as multi-dimensional functions, can be handled. Thus, it would be advantageous to provide a method that quickly determines if a range of voxels contain valid opacities for almost any type of classification function. It would also be beneficial if such a method were fully automated.

All of the previously described techniques to find valid groups of voxels can also be used to find valid groups of samples. These techniques might be useful when the volume of voxels has already been fully interpolated for a viewpoint and converted into a volume of samples. Normally, this is not very beneficial because the acceleration technique would not be able to support changes in viewpoint. In this case, the volume would have to be fully sampled again.

A common technique used in software-based volume rendering systems on standard CPUs to conserve processing effort is to stop the processing of a voxel or sample if its opacity is less than a predetermined value (typically zero). This avoids having to calculate gradients, shading, and compositing of the voxel or sample. This technique, however, cannot easily be extended to SIMD based systems. For example, a SIMD-based system typically would need to individually look up the opacity value in every voxel in its vector command. This is a very slow process because each value has to be looked up sequentially. Additionally, many systems require the result to be shifted in the output vector. This process takes many cycles because the lookup cannot be done in parallel. It would be more beneficial if the system could determine beforehand whether the voxels and samples will have a valid opacity without actually calculating the opacity whereby only the good voxels and samples are passed onto the slow classification step based on lookup tables.

### BRIEF DESCRIPTION OF THE DRAWINGS

The above needs are at least partially met through provision of the fast imaging data classification method and apparatus described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises an example histogram displaying a count of a voxel data set against the densities of the voxel data;

FIG. 4 comprises the example histogram of FIG. 3 including a superimposed example opacity classification function;

FIG. 5 comprises a representation of an example classification function and prior art calculation of opacities for the classification of various data points;

FIG. 6 comprises a representation of an example classification function and example valid ranges as configured in accordance with various embodiments of the invention;

FIG. 7 comprises a flow diagram as configured in accordance with various embodiments of the invention;

FIG. 8 comprises a representation of an example classification function and example valid ranges as compared to example value intervals as configured in accordance with various embodiments of the invention;

FIG. 9 comprises a flow diagram as configured in accordance with various embodiments of the invention;

FIG. 10 comprises a representation of an example two dimensional classification function as may be used in various embodiments of the invention;

FIG. 11 comprises a representation of the one dimensional density value based classification function that corresponds to the density axis of the multi-dimensional classification function depicted in FIG. 10;

FIG. 12 comprises a representation of the one dimensional gradient magnitude based classification function that corresponds to the gradient magnitude axis of the multi-dimensional classification function depicted in FIG. 10;

FIG. 13 comprises a representation of an example multi-dimensional classification function as may be used in various embodiments of the invention;

FIG. 14 comprises plan view of the representation of FIG. 13 including a bounding box around the valid portion of the multi-dimensional classification function of FIG. 13;

FIG. 15 comprises plan view of the representation of FIG. 13 including multiple bounding boxes around the valid portion of the multi-dimensional classification function of FIG. 13;

FIG. 16 comprises a plan view representation of two bounding boxes surrounding two valid portions of a multi-dimensional classification function as may be used in various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENT(S)

Generally speaking, pursuant to these various embodiments, image data is acquired, and at least one predetermined range of valid values is derived from each of one or more portions of a classification function. Then, a comparator circuit or similar structure determines a status of a value of at least one value type of the image data with respect to at least one predetermined range of valid values for the value type. Then, the image data is defined at least in part as a function of the status of the image data with respect to the at least one predetermined range of valid values. The image data that falls within the predetermined range(s) of valid values of one or more portions of the classification function may then be passed for further processing to contribute to a displayed image.

By so processing the image data, one may determine relatively quickly whether parts of the image data are valid without fully calculating the opacity or other value for the image data, thereby accelerating the volume rendering processing of individual voxels and samples and/or improving existing acceleration techniques that eliminate groups of voxels and samples from the volume rendering process. Similarly, a large look-up table need not be used to determine whether the image data is valid for every classification function or every portion of a classification function or multi-dimensional classification function. As such, it can be quickly determined whether a group of voxels or samples has voxels or samples of interest within it. It is possible, then, to perform the same preprocessing as for single voxels and samples as for voxel and sample ranges.

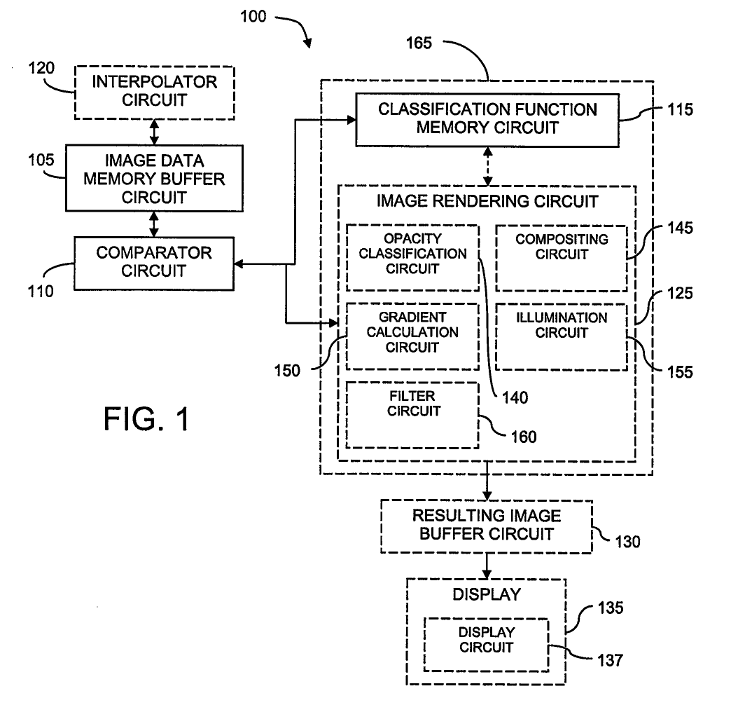

These and other benefits may become clearer upon making a thorough review and study of the following detailed description. Referring now to the drawings, and in particular to FIG. 1, a system 100 for classifying data used to provide a resulting image from a set of three dimensional data typically includes an image data memory buffer circuit 105 operatively coupled to a comparator circuit 110. The comparator circuit 110 is also operatively coupled to a classification function memory circuit 115 such that the comparator circuit 110 can compare image data from the image data memory buffer circuit 105 to at least one given range of valid values. The ranges of valid values are stored in or determined from a classification function stored in the classification function memory circuit 115. Alternatively, the system 100 may operate on the image data to determine a range of invalid values with appropriate logic changes to achieve the same goals as discussed herein. An example embodiment determining valid values is discussed further herein. The comparator circuit 110 is typically a processor circuit such as one or more of the following examples: a field programmable gate array, an application specific integrated circuit (“ASIC”) based chip, and a digital signal processor (“DSP”) chip, each of which is known and used in the art. Other, and as of yet undeveloped circuits, may also be used as a processor circuit for various portions of the system.

By one approach, the image data is processed through an interpolator circuit 120 such that the interpolator circuit 120 may provide interpolated sample values as image data for the image data memory buffer circuit 105 or directly to the comparator circuit 110 for processing. As such, the interpolator circuit 120 may be operatively coupled to the image data memory buffer circuit 105 and/or the comparator circuit 110. Thus, in various approaches, the image data may come directly from other sources or data acquisition devices such as a medical scanner or other data provider. For example, the image data may result from a raycasting technique, as described above, where the data may be converted from object space to image space with a rotation transformation and then be further interpolated.

Typically, an image rendering circuit 125 is operatively coupled to the comparator circuit 110 to operate upon valid image data passing from the comparator circuit 110. Optionally, a resulting image buffer circuit 130 is operatively coupled to the image rendering circuit 125 to receive resulting image data. A display 135 and display circuit 137 are operatively coupled to the resulting image buffer circuit 130 to display the resulting image. The display 135 may be any device that can display images. The display circuit 137 may include a typical display processing board separate from a display 135 or may be integral with the display 135.

The image rendering circuit 125 may also include an opacity classification circuit 140 and a compositing circuit 145. Further, the image rendering circuit 125 may also include a gradient calculation circuit 150 and an illumination circuit 155. Similarly, the image rendering circuit 125 may include a filter circuit 160 for removing additional invalid image data from the processing pipeline. Such portions of the system 100 may be arranged as needed to complete the image data processing pipeline hardware for rendering the three dimensional or volume data into various displayed images.

Those skilled in the art will recognize and understand from these teachings that such a system 100 may be comprised of a plurality of physically distinct elements as is suggested by the illustration shown in FIG. 1. It is also possible, however, to view this illustration as comprising a logical view, in which case one or more of these elements can be enabled and realized via a shared platform. For instance, the opacity classification circuit 140, compositing circuit 145, gradient calculation circuit 150, and illumination circuit 155 may be separate chips or circuits, or may be combined into a single chip or circuit, such as being part of a single image rendering circuit 125. Similarly, the opacity classification circuit 140 or image rendering circuit 125 may be integral with the classification function memory circuit 115, as represented as a single unit 165. It will also be understood that such a shared platform may comprise a wholly or at least partially programmable platform as is known in the art.

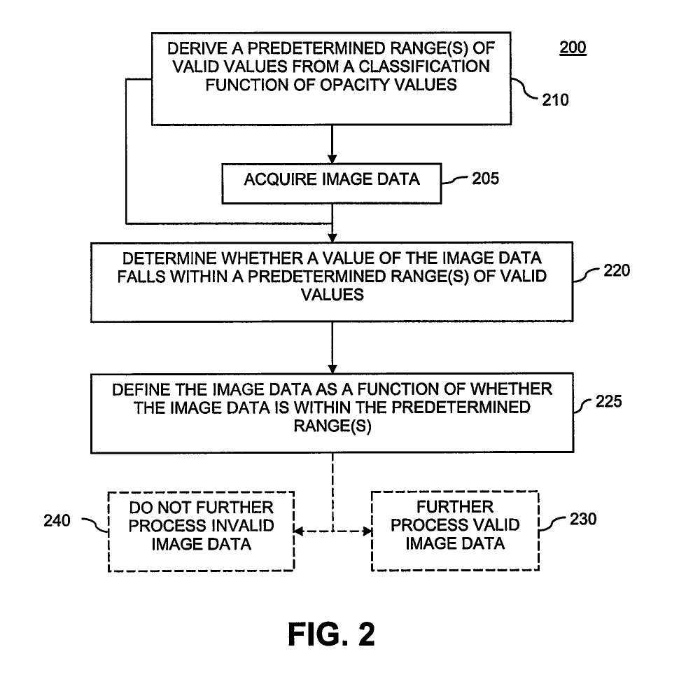

With reference to FIG. 2, a method 200 of operation for the system 100 includes acquiring 205 image data, typically from the image data memory buffer circuit 105. The image data may originate from a medical scan, such as a CT scan or MRI scan, or from an otherwise acquired set of volume data, as discussed herein, such as from a created set of video game image data. By one approach, the image data may be interpolated by an interpolator circuit 120 prior to being acquired 205. Also, the image data may be acquired and manipulated in various forms. Thus, when acquiring 205 the image data to be processed, one may acquire at least one of a single sample value, a range of sample values, a single voxel value, or a range of voxel values. As understood in the art, three dimensional image data or volume data is stored or indexed such that a data point within the data set includes the relevant data for a given point in the imaged three dimensional space. The relevant data may represent a variety of value types that include any value that may be associated with that point in space such as density, gradient, and temperature. The data points and their associated data are typically referred to as voxels in the art. It is also common in the art to use an alternative definition of voxels, where voxels are equivalent to the set of adjacent data points that form polyhedra within the volume data set. This document exclusively uses the former definition. When using the image data, the data can be used as samples, which are data points that are derived from neighboring voxels and which fall between the input voxels. These samples are typically calculated through a reconstruction and sampling process referred to as interpolation. By another approach, one may manipulate or use the image data by using a range of samples or a range of voxels.

The method 200 may also include deriving 210 at least one predetermined range of values from a classification function of opacity values for the resulting image. The predetermined ranges may be of valid or invalid values with appropriate logic changes to achieve the same goals. An example embodiment determining valid values is discussed further herein. The predetermined ranges of valid values are processed from the classification function and recorded or stored in the classification function memory circuit 115 or other memory. This derivation from the classification function(s) can be done before or after acquisition 205 of the image data.

By one approach, the derivation 210 includes analyzing the classification function(s) or table(s) to determine the range(s) of each portion of the classification function that has an opacity greater than a predetermined value (typically zero). For example, in a one-dimensional classification function, one range is determined for each portion, where the range corresponds to the classification function's maximum and minimum values within the portion. For more complicated multi-dimensional classification functions, one or more bounding objects (e.g., a box or cube) are used to enclose and define the valid portions(s) from which the valid ranges may be determined. The bounding objects may enclose portions of the classification function that have values less than the predetermined value. The range(s) defined by the bounding objects, however, will typically enclose all the valid values for the classification function.

Because preset parameters usually define the classification tables, these valid range(s) are usually known in advance. When the user creates or manually modifies the classification function(s), these values are also typically known by the software that creates the lookup tables corresponding to the classification function. Such available values can be used directly. If the values are not available, then the opacity values in the tables or classification function(s) are passed over, and the voxel and sample values that change from an opacity value below or equal to a predetermined value to one that is above the predetermined value are determined. These transitional values are then directly used as the valid ranges of the classification table. For multi-dimensional classification functions, these transitional values are then used to define one or more bounding objects per portion of the multi-dimensional classification function. The transitional values that were used to define the bounding objects are then recorded as the valid range(s) of the classification function. These valid ranges(s) represent the portions of the classification function that have good data values. Alternatively, the intervals that represent invalid values could be recorded. When the classification function changes, the whole process does not typically need to be repeated. Instead, the user may alter one point of the classification function at a time and this information can be directly passed from the user-interface software to the software that records the valid ranges of the classification function. A simple update of only one of the ranges is typically needed.

Classification functions can be fully predefined or they can be created by the user through a user interface. A classification table can be based on either the values stored at the samples and voxels or they can be based on new derived values. For example, CT medical data typically uses density at the voxel and sample and calculated gradient magnitude to form a multi-dimensional classification function. Additional variables such as curvature and lighting characteristics can also be used. One should note that in the art, multi-dimensional classification functions typically are not implemented as true multi-dimensional tables because they require more storage and can be difficult to modify by a user. Instead multi-dimensional classification functions are typically approximated by looking up several one dimensional classification tables in succession. Each classification table is based on a different variable. In a previous approach to handling these issues, in a multi-dimensional classification function based on density and gradient magnitude, first the opacity and color would be looked up in the density based classification table. Then the opacity and color of the gradient-based classification table would be looked up. The two results would be multiplied together, possibly with a weight, resulting in the final color and opacity. This approach to multi-dimensional classification tables also simplifies the determination of the value ranges(s) because bounding objects are not needed for one dimensional classification functions. The approaches described herein, however, may be adapted to any known form of classification function or table.

With continuing reference to FIG. 2, a comparator circuit 110 determines a status of a value of at least one value type of the image data with respect to the at least one predetermined range of valid values for the value type. By one approach the comparator circuit 110 determines 220 whether a value of at least one value type of the image data falls within at least one predetermined range of valid values for the value type, typically using a classification function stored in the classification function memory circuit 115. The image data is defined at least in part as a function of the status of the value of at least one value type of the image data with respect to the at least one predetermined range of valid values. Consistent with the above approach, the image data is defined 225 as a function of whether the image data is within the at least one predetermined range of valid values. In other words, the image data is determined to be or defined as valid (may contribute to the final image) or invalid (will not contribute to the final image). Although this disclosure primarily describes one method of comparing image data to the predetermined ranges, the teachings of this disclosure may be applied to various methods of comparing the image data to the predetermined ranges. For example, the image data may be defined either as within or outside the ranges of valid values or as within or outside the ranges of invalid values.

In other words, instead of calculating an opacity and evaluating its value, the value(s) of the input voxel or sample are compared to the classification range(s) stored in the preprocessing step. For a one dimensional classification function, for example, the value of the voxel or sample is checked to see if it falls within one of the valid ranges recorded for the valid portions of the classification function. If it is within a valid range then the value is passed onto the volume rendering steps of classification, gradient calculation, shading, and compositing. If the value is not within any of the valid range(s) of the classification function(s), however, it does not need to be processed anymore.

If the classification function is multi-dimensional, then the voxel or sample may not be proven valid until its secondary values, such as gradient magnitude, are compared with the secondary valid ranges for the value types of that same portion of the classification function. Accordingly, the image data may be defined 225 with respect to many value types that may make up the image data. Example value types include density, gradient, second order gradient, curvature, magnetic field, velocity, and temperature. If all values associated with a sample or voxel fall within the value type's valid ranges for one or more portions of the classification function, then the sample or voxel is valid. If the sample is not valid for one value type of a portion of the classification function, it does not need to be tested against the other value types of the same portion because it is already known to be invalid. In the example where a multi-dimensional classification function is used with two or more bounding objects to define the predetermined ranges, the sample should then be tested against the predetermined ranges of the next portion. If the sample is valid for the next portion of the classification function there is no need to continue processing. If the sample is invalid, the next portion is tested and so on. The test to determine if a value is within a valid range is performed by determining whether the value is less than the maximum value of the valid interval and greater than or equal to the minimum value of the valid interval. By another approach, the Boolean compliment of this comparison test could also be used. By yet another approach, the invalid ranges of the classification table could be used in a likewise manner.

As such and with continuing reference to FIG. 2, the image data may be defined as valid when the image data falls within the at least one predetermined range(s) of valid values such that the image data is further processed 230 toward providing a resulting image. Similarly, the image data may be defined as invalid when the image data falls outside all of the predetermined range(s) of valid values such that the image data is not further processed 240 with respect to providing the resultant image. Image data that will not contribute may be removed from the image rendering process to increase processing and memory efficiency and the speed of the image rendering process. Optionally, the classification function used to derive the ranges of valid values is just one of a plurality of classification functions or a multi-dimensional classification function such that the image data may be processed in a number of ways to allow a user to view various representations of the data.

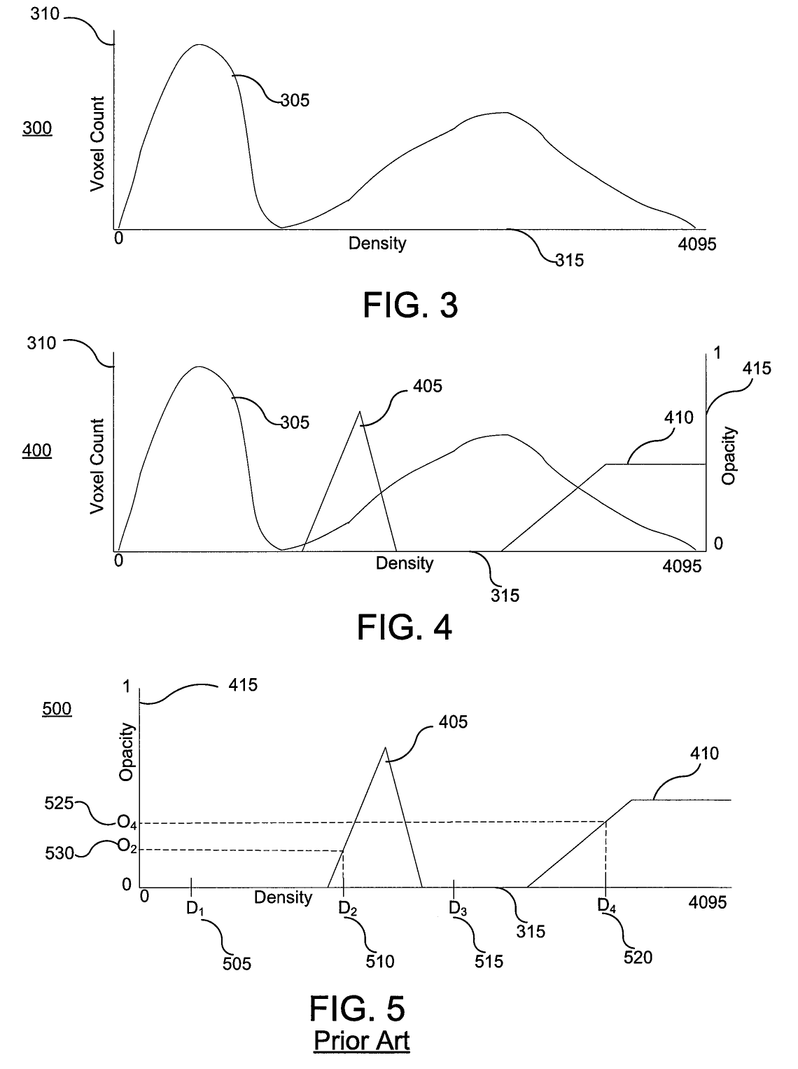

Examples of the comparison process will be described below with reference to FIGS. 3-16. Initially the process for one-dimensional classification functions will be described. FIG. 3 shows a graph 300 with a histogram of an example set of voxel image data 305 of a density value type. The vertical axis 310 indicates the voxel count for density values ranging from zero to 4095 on the horizontal axis 315. FIG. 4 shows a graph 400 with the same example histogram and a representation of an example one dimensional classification function with two portions 405 and 410: a first valid portion 405 and a second valid portion 410. The classification function ranges from 0 to 1 on the second vertical axis 415 based on the opacity of the density values.

In prior art systems, as demonstrated in the graph 500 shown in FIG. 5, to determine whether a particular data point has a valid opacity value, the opacity values for data points D₁ 505, D₂ 510, D₃ 515, and D₄ 520 are calculated according to the classification function portions 405 and 410. The calculated opacity values for data points D₁ 505 and D₃ 515 are zero and thus invalid and will not contribute to a resulting displayed image, while the calculated opacity values for data points D₄ 520 and D₂ 510 are the valid values O₄ 325 and O₂ 330, respectively. Calculating each of these four opacity values necessitates a certain amount of processing power, and calculating the opacity values for every data point of a set of volume data necessitates significant processing power or enough memory to store a large look-up table. Also, should the classification function portion 405 and/or 410 change, a new large look-up table must be calculated and/or stored.

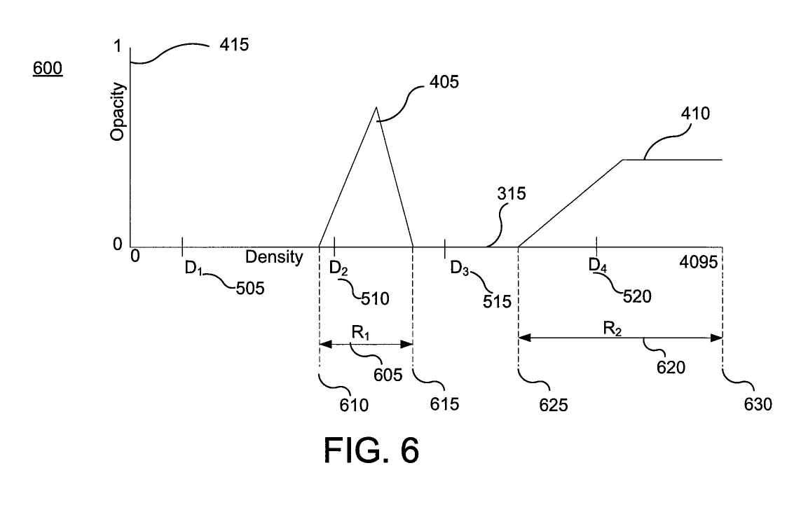

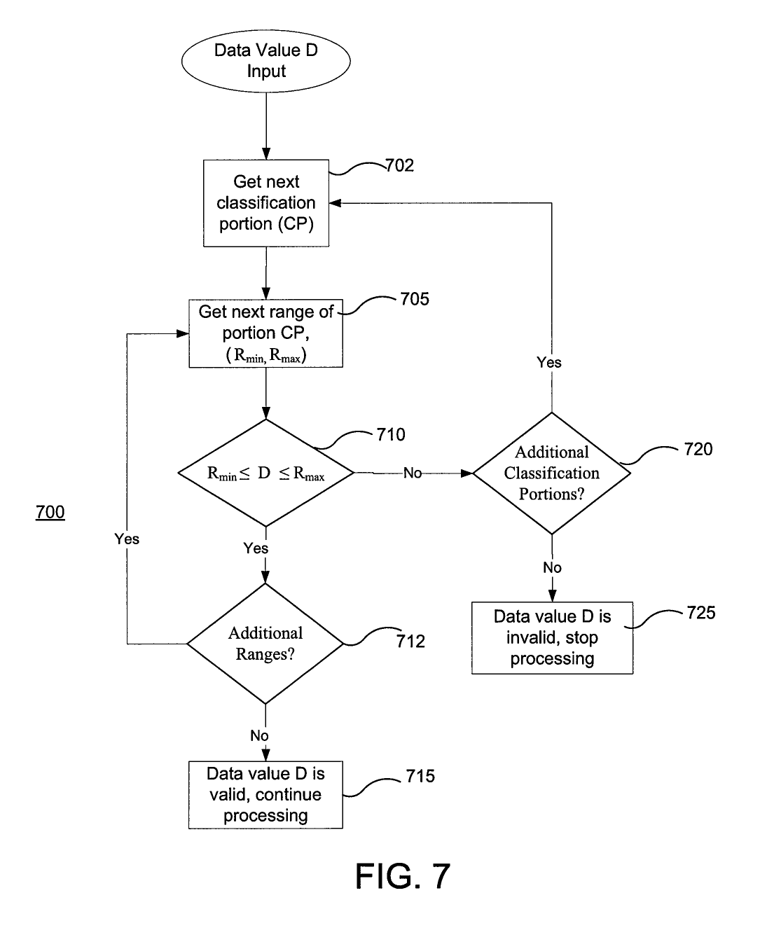

According to one approach for the method 200 of operation of FIG. 2, when acquiring a single sample value, the step of determining 220 whether a value of at least one value type of the image data falls within at least one predetermined range(s) of valid values includes determining whether the single sample value falls within at least one predetermined range(s) of valid values that represent the valid portions of the classification function or, in the case of certain multi-dimensional classification functions, determining whether the single sample value falls within all of the predetermined ranges of valid values of at least one valid portion of the classification function. Similarly, when acquiring a single voxel value the step of determining 220 whether a value falls within at least one predetermined range(s) of valid values includes determining whether the single voxel value falls within at least one predetermined range of values that represent the valid portions of the classification function or, in the case of certain multi-dimensional classification functions, determining whether the single voxel value falls within all of the predetermined ranges of valid values of at least one valid portion of the function. These approaches for one-dimensional classification functions will be further described with reference to FIGS. 6 and 7.

FIG. 6 shows a representation 600 of the example one dimensional classification function 405 and 410. The first classification function portion 405 defines a first valid range R₁ 605 between the end values 610 and 615. Similarly, the second valid portion 410 of the classification function defines a second range R₂ 620 between the end values 625 and 630. The ranges R₁ 605 and R₂ 620 are relatively easy to compute according to the description above in comparison to computing opacity values for every data point for the image data. The ranges R₁ 605 and R₂ 620 may be calculated in a separate processor circuit (not shown) operatively coupled to the device 100 or in the image rendering circuit 145 during the image processing or before the image processing. If the ranges R₁ 605 and R₂ 620 are pre-calculated, the ranges R₁ 605 and R₂ 620 can be stored in the classification function memory circuit 115 and used until the classification function is changed. Recalculating the ranges R₁ 605 and R₂ 620 upon a change of the classification function is similarly not typically overly taxing on processor or memory resources.

With reference to FIGS. 6 and 7, once the ranges R₁ 605 and R₂ 620 are determined, the values of the image data may be processed. In this example, the data points D₁ 505, D₂ 510, D₃ 515, and D₄ 520 may represent either single sample values or single voxel values. For each data value D, the processing process 700 includes calling up or getting 702 the next classification function portion from the classification junction memory circuit 115. Then, the comparator circuit 110 gets 705 the range R₁ 605 of the next portion 405 from the classification function memory circuit 115, and the data value D from the image data is compared 710 to the minimum and maximum values of the range R₁ 605. If the data value D is between the minimum and maximum values of the range R₁ 605, the system will determine 712 whether additional ranges of the portion (yes if the data is multi-dimensional and not all of the ranges of the portion have been checked as valid, no if the data is one-dimensional like that of FIG. 6) need to be processed. If not, the system will continue processing 715 the data value D. If the data value D is outside of the minimum and maximum values of the range R₁ 605, the comparator circuit 110 checks 720 whether additional classification portions exist against which the data value D must be compared. In this example, the data value D must be compared to the range R₂ 620 of the second portion 410, so steps 702, 705 and 710 are repeated where the data value D is compared to the minimum and maximum values of range R₂ 620 of the second portion 410. If the data value D is outside of the minimum and maximum values of the range R₂ 620, the comparator circuit 110 checks 720 whether additional classification portions exist against which the data value D must be compared. Because no other regions exist, the comparator circuit 110 stops 725 processing the data value D. Typically, the image rendering circuit 125 will also then stop processing the data value D if the data value is defined as invalid.

According to another approach for the method 200 of operation of FIG. 2, when acquiring a range of sample values, the step of determining 220 whether a value of the image data falls within at least one predetermined range of valid values includes determining whether at least a portion of the range of sample values overlaps with at least a portion of the at least one predetermined range of valid values. Similarly, when acquiring a range of voxel values, the step of determining 220 whether a value of the image data falls within at least one predetermined range of valid values includes determining whether at least a portion of the range of voxel values overlaps with at least a portion of the at least one predetermined range of valid values.

In other words, with both the range information from the classification function(s) and the volume subsections, the subsections or groups with valid voxels or samples contained within it may be determined. If the subsection's interval overlaps with any of the ranges of the valid portions of the classification table, the subsection contains at least one valid voxel or sample. The full subsection should then be processed by the rest of the volume rendering pipeline, although there may be voxels or samples within the subsection that are not of interest. According to this example, as long as one voxel or sample is of interest according to this approach, the whole subsection must be processed. Other teachings of this disclosure regarding evaluating individual samples and voxels may be used to perform a finer grain filtering of the valid subsection. If the subsection's interval does not overlap with any of the portion's valid ranges, then the subsection does not contain any valid voxels or samples and the processing of the subsection can stop. In one approach, the interval comparison is performed by determining whether the subsection's maximum value is less than the minimum value of the classification function's range(s) and whether the subsection's minimum value is greater than the maximum value of the classification function's range(s). If this comparison is true for at least one range of the classification function, the subsection contains valid voxels or samples. As discussed above, the reverse of this comparison test (defining invalid voxels or samples) could also be applied.

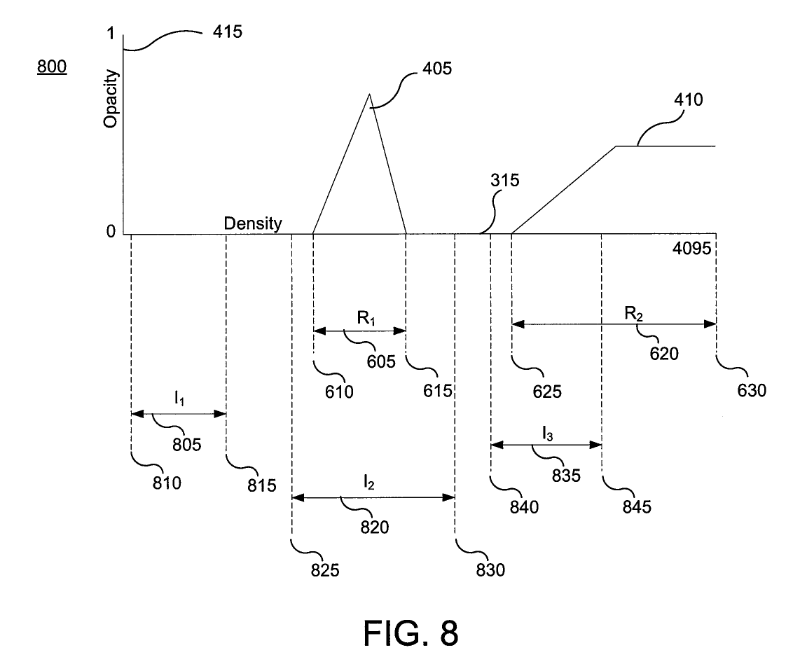

FIG. 8 shows a representation 800 of the classification function portions 405 and 410 and various data ranges. The classification function ranges R₁ 605 and R₂ 620 are determined as described above. Instead of comparing single samples or voxels, however, in this example data intervals of samples or voxels may be compared to the ranges R₁ 605 and R₂ 620. The first interval I₁ 805 of samples or voxels is defined between two end points 810 and 815; the second interval I₂ 820 of samples or voxels is defined between two end points 825 and 830; and the third interval I₃ 835 of samples or voxels is defined between two end points 840 and 845.

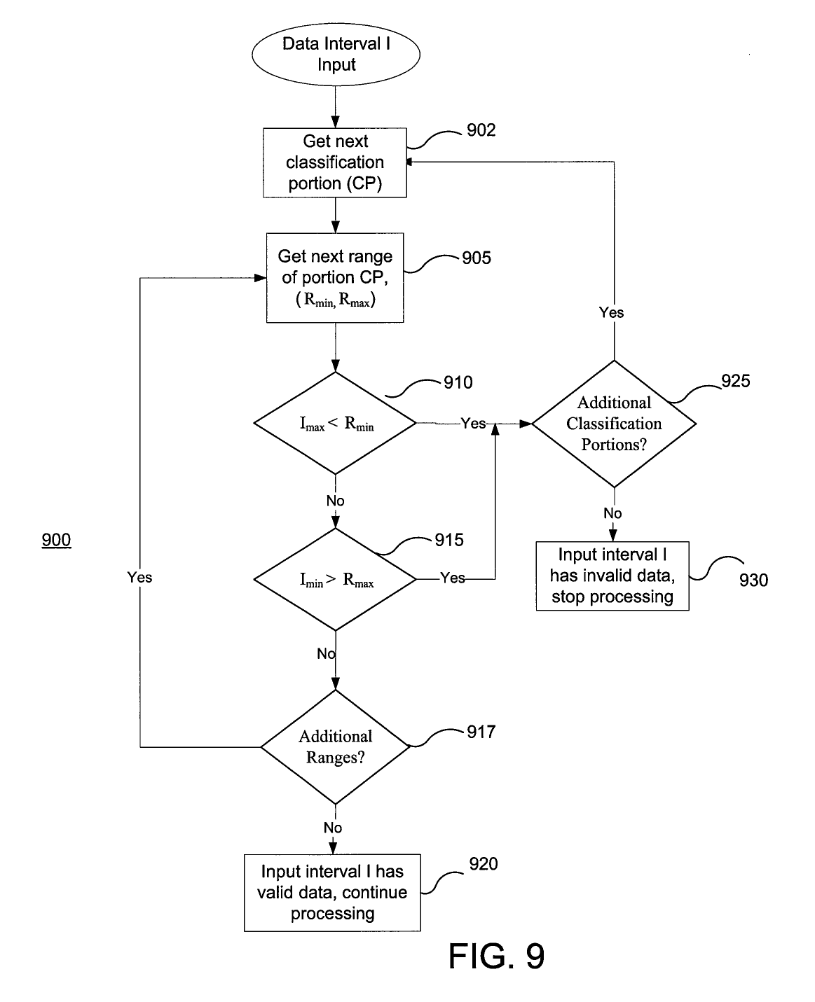

With reference to FIGS. 8 and 9, for each value interval I₁ 805, I₂ 820, and I₃ 835, the example processing process 900 includes the comparator circuit's 110 getting 902 the next classification function portion from the classification function memory circuit 115. Then, the comparator circuit 110 gets 905 the next range R₁ 605 from the classification function memory circuit 115, and the maximum Iₘₐₓ of the interval from the image data memory buffer circuit 105 is compared 910 to the minimum value of the range Rₘᵢₙ. If the maximum Iₘₐₓ of the interval is not less than the minimum value of the range Rₘᵢₙ, the comparator circuit 110 compares 915 the minimum Iₘᵢₙ of the interval with the maximum value of the range Rₘₐₓ. If the minimum Iₘᵢₙ of the interval is not more than the maximum value of the range Rₘₐₓ, the interval overlaps with the valid range. The system determines 917 whether any additional ranges of the portion (yes if the data is multi-dimensional and not all of the ranges of the portion have been checked as valid, no if the data is one-dimensional like that of FIG. 6) should be processed. If not, the system will continue processing 920 the data represented by the input interval. If the maximum Iₘₐₓ of the interval is less than the minimum value of the range Rₘᵢₙ or if the minimum Iₘᵢₙ of the interval is more than the maximum value of the range Rₘₐₓ, the interval does not overlap with the valid range R, and the system checks 925 whether there are additional classification portions against which to check the interval. If additional portions exist, the above described processing repeats by getting the next classification portion 902. If no other portions exist, the comparator circuit 110 stops 930 processing the interval. Typically, the image rendering circuit 125 will also then stop processing the interval if the interval is defined as invalid.

For such an approach for each classification function portion, the valid range(s) of voxels or samples is determined and recorded in a small table as previously described above. The second step is to determine the range or interval of values contained within the group of voxels or samples. This information is determined during a preprocessing step where the input volume data set is stored as a spatial data structure (e.g., octrees, pyramids, and K-d trees) or a value sorted data structure. The spatial data structure does not need to be hierarchical, it just needs to store all of the intervals associated with different subsections of the volume. The process that creates these data structures can be part of the system concept described herein or they can be independent acceleration algorithms. In either case, the intervals created by the data structures may be used by systems built according to concepts described herein. If no predetermined data structures exist, the input volume data set can be passed over and intervals can be recorded for different subsections of the volume. Typically, intervals are calculated for equal sized cube subsections of the volume data set.

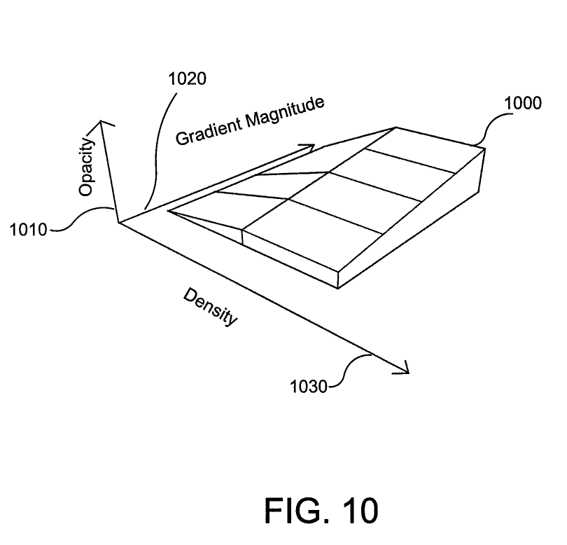

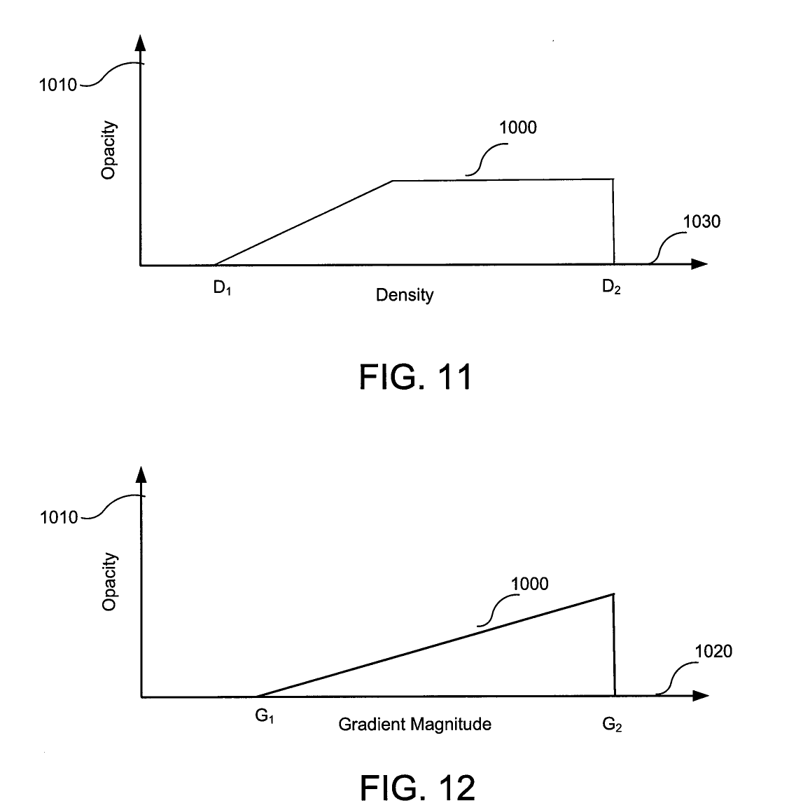

Such processes can be applied to more complicated multi-dimensional classification functions as well. Most multi-dimensional classification functions require multi-dimensional lookup tables to hold all of the opacity values at each unique data point. These multi-dimensional lookup tables require significantly more storage than a one-dimensional classification function and are difficult to modify. As a result, most volume rendering systems restrict the multi-dimensional classification functions to cases where the additional dimensions scale with the original one dimensional classification function. That is, instead of having an opacity function based on multiple variables, the opacity function is based on only one data value and then scaled according the value of the next data value and so on. FIG. 10 illustrates one such example of a multi-dimensional classification function for opacities based on the data types of gradient magnitude and density. The valid opacity values of the example multi-dimensional classification function is shown by a multi-dimensional classification function portion 1000. The multi-dimensional classification function depicts the opacity (as represented on the z axis 1010) as it varies according to gradient magnitude (as represented on the x axis 1020) and density (as represented on the x axis 1030). Because the gradient magnitude in multi-dimensional classification function portion 1000 only scales the density based opacity values, the multi-dimensional classification function can be represented as two separate one-dimensional classification functions as depicted in FIGS. 11 and 12. The ranges of each one-dimensional classification function portion (D₁ to D₂ and G₁ to G₂) are the valid ranges of the portion 1000 of the multi-dimensional classification function depicted in FIG. 10.

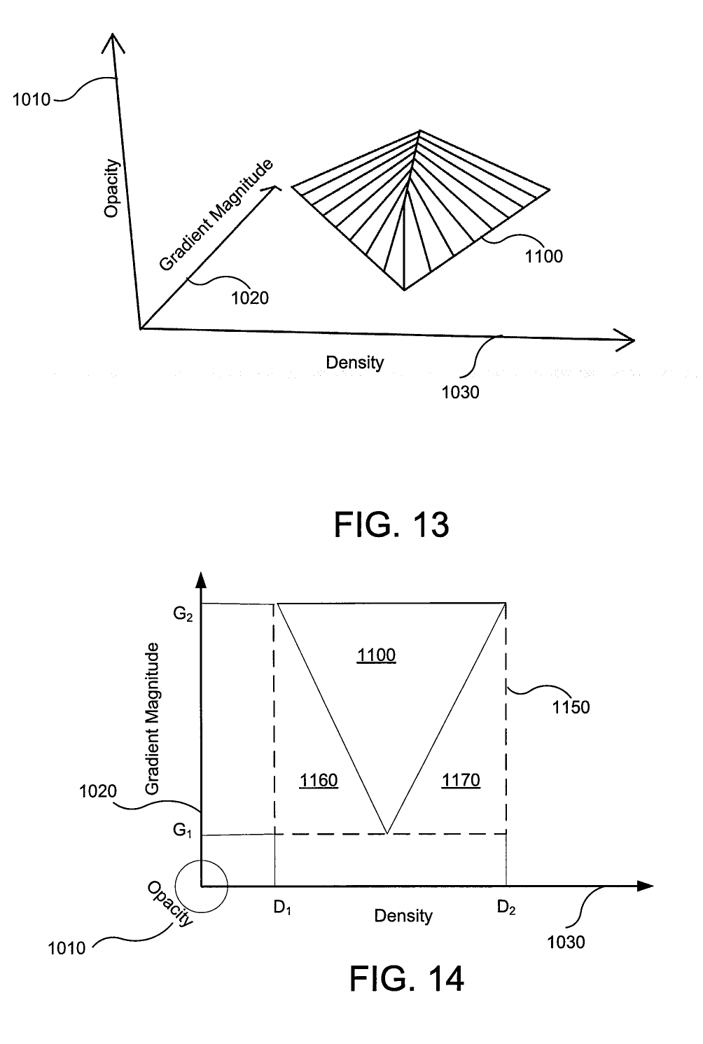

The multi-dimensional classification function depicted in FIG. 13 is an example of a multi-dimensional classification function that can not be simplified to multiple one dimensional classification functions. In this case, the opacity is based on a function with two independently varying input variables, density and gradient magnitude. The ranges for this classification function portion 1100 are calculated by placing a bounding object, here for example a box 1150, around the classification function portion 1100 as shown in FIG. 14. FIG. 14 depicts the classification function portion 1100 of FIG. 13 from above, looking down onto the density-gradient magnitude plane. The bounding box 1150 of FIG. 14 surrounds the classification function portion 1100 of FIG. 13 and is used to calculate the potentially valid ranges of density and gradient magnitude for the acquired data. The depicted ranges (D₁ to D₂ and G₁ to G₂) that define the size and shape of the bounding box 1150 contain some values (those in bounding box portions 1160 and 1170) that will be invalid and therefore will not ultimately contribute to the output image. Processing this invalid data reduces the efficiency of the system because some invalid data will be processed, however, the majority of the invalid data will be removed from the process and every valid data value will be processed.

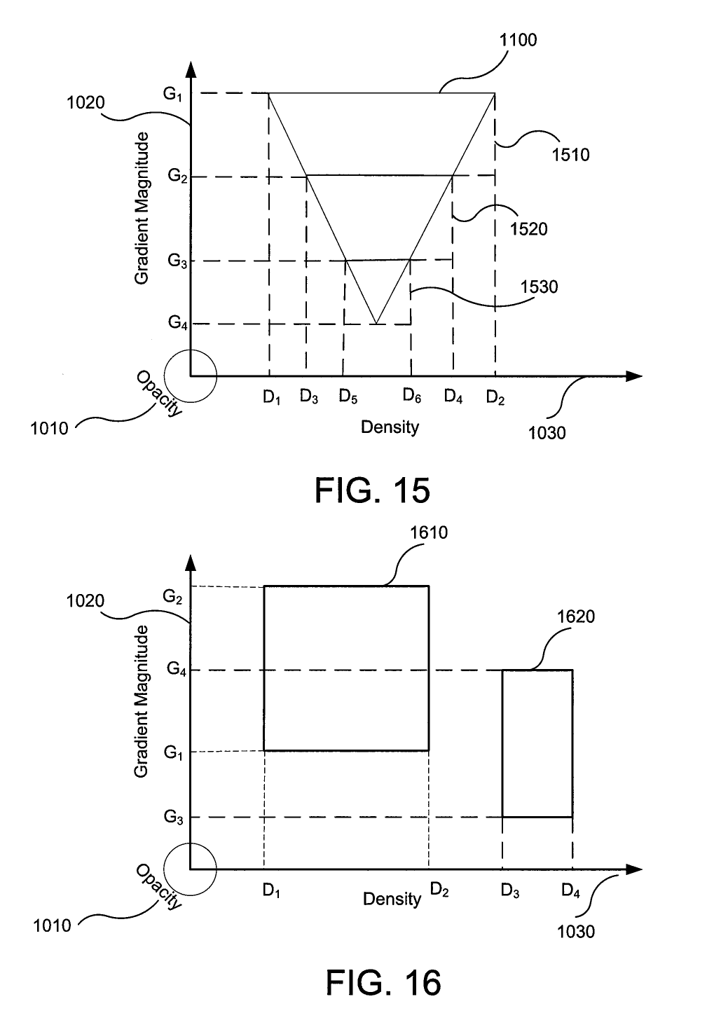

If the efficiency needs to be further increased in a given system, i.e., if the number of invalid data values removed from the process must be increased, the number of invalid values in the bounding object may be reduced by using several smaller bounding objects to enclose the classification function portion 1100, as shown in FIG. 15. The bounding boxes include a first large box 1510 defined by the points D₁ to D₂ and G₁ to G₂; a second, medium sized box 1520 defined by the points D₃ to D₄ and G₂ to G₃; and a third, small box 1530 defined by the points D₅ to D₆ and G₃ to G₄. So configured, less invalid data is captured by the bounding objects 1510, 1520, and 1530 than that the single bounding box 1150 of FIG. 14. In this case, the input data value or interval will be compared against the ranges of each bounding box 1510, 1520, and 1530. If the input data value or interval falls within any of the bounding boxes, the input data value or interval is valid and must be further processed by the system. Otherwise, the input data value or interval is invalid and no additional processing is required.

With reference to FIG. 16, it is also possible that a multi-dimensional classification function covers multiple multi-dimensional portions of the multi-dimensional classification function, similar to the multiple portions 405 and 410 of the one-dimensional classification function of FIGS. 4-6. That is, some of the values of the classification function may be non-valid such that parts of the classification function become disconnected from each other. In this case, one or more bounding boxes 1610 (defined by points D₁ to D₂ and G₁ to G₂) and 1620 (defined by points D₃ to D₄ and G₃ to G₄) can be used for each portion of the classification function as shown, for example, in FIG. 16. If the classification function extends beyond two variables, the same bounding object technique can be used. For example, a cube can define the predetermined portion(s) for a three dimensional classification function.

Thus, by one example approach, to determine whether the acquired data should be further processed for a multi-dimensional classification function, each portion of the classification function will contain a predetermined range for each data type as defined by the bounding object. For example, if a multi-dimensional classification table is based on density and gradients, a range of values will be determined for both the density and the gradient data types of each classification function portion. If the intervals associated with a subsection of data do not overlap with all of the respective ranges of a classification function portion, as defined by a bounding object, the subsection is invalid for that particular portion and must be checked against the other portions of the classification functions as defined by the other bounding object(s). If the intervals of the data subsection are invalid for all classification function portions, the processing of the subsection can stop because the subsection does not have any valid data. The valid subsection of acquired data as determined by the above methods is recorded in a small table.

So configured, the only memory required is a small table containing the valid ranges of the classification function. Typically, classification functions only contain a couple of ranges. A SIMD based computer can take direct advantage of this example. A SIMD system could use a vector command to compare multiple voxels or samples in parallel with a valid range from the classification table. This command would only need to be repeated a couple of times for all of the valid ranges. Upon completion, it would be known which voxels or samples are to be processed by the volume rendering system. In effect, invalid voxels and samples are eliminated. This parallel method typically would be faster than sequentially looking up each voxel and sample in a classification lookup table. In addition, this method would be directly applicable to hardware-based volume renderers that cannot always afford the memory to use large lookup tables. Thus, significant processing and memory resources are typically conserved.

Those skilled in the art will appreciate that the above-described approaches to the process 200 are readily enabled using any of a wide variety of available and/or readily configured platforms, including partially or wholly programmable platforms as are known in the art or dedicated purpose platforms as may be desired for some applications. FIG. 1 as discussed above illustrates one preferred approach to such a platform. Another approach includes an opacity modulation circuit as a sub-circuit of the opacity classification circuit 140. The opacity modulation circuit can modulate the resulting opacity by using additional variables such as gradient magnitude. Another possible platform incorporating the comparator circuit 105 and classification function memory circuit 115 can be used to implement splatting. A splatting platform would use similar components as FIG. 1 but the components would be used in different order and some circuits would be modified, for example, to include a Gaussian filter circuit, as can be done by one skilled in the art.

Those skilled in the art will also recognize that a wide variety of modifications, alterations, and combinations can be made with respect to the above described embodiments without departing from the spirit and scope of the invention. For instance, the opposite comparisons than those described above may be made to determine whether a data value or interval of values are valid. For example, image data intervals can be compared against predetermined ranges of invalid data values based on the classification function. The teachings of this disclosure may also be used with numerous existing volume rendering acceleration algorithms. For example, teachings of this disclosure may be applied to a shear warp algorithm to quickly determine whether a subsection of an octree has valid values within it. This can be done without having to perform a significant amount of preprocessing every time the classification function tables change. In addition, little processing power or memory is needed. The memory holds the different range values. The teachings of this disclosure may also allow acceleration algorithms based on spatial data structures to support changes in viewpoint and classification functions without having the negative traits associated with value added data structures, such as having to explicitly store voxel locations.

While the described embodiments are particularly directed to rectilinear volume data forming rectangular parallelepiped voxels, there is nothing contained herein which would limit use thereto. Any type of volume data and their associated voxels or samples, be it rectilinear, curvilinear, unstructured, or other, is amenable to processing in accordance with these teachings. As such, virtually any system capable of generating volume data may process such data in accordance with these teachings. For example, these teachings are not limited to use with octrees and K-d trees. Virtually any volume rendering system capable of subdividing a volume and generating range values for each subsection is amenable to processing in accordance with these teachings. Such modifications, alterations, and combinations are to be viewed as being within the ambit of the inventive concept.

I claim:

1. A method of classifying data used to provide a resulting image from a set of volume data comprising:
acquiring image data;
deriving at least one predetermined range of values from a classification function for the resulting image;
determining a status of a value of at least one value type of the image data with respect to the at least one predetermined range of valid values for the value type;
defining the image data at least in part as a function of the status of the value of at least one value type of the image data with respect to the at least one predetermined range of values.

2. The method of claim 1 wherein the at least one value type includes at least one of the group of value types comprising density, gradient, second order gradient, curvature, magnetic field, velocity, and temperature.

3. The method of claim 1 wherein acquiring image data further comprises acquiring at least one of the group comprising:
a single sample value;
a range of sample values;
a single voxel value; and
a range of voxel values.

4. The method of claim 3 wherein when acquiring a range of sample values the step of determining a status of a value of at least one value type of the image data with respect to the at least one predetermined range of values for the value type further comprises determining whether at least a part of the range of sample values overlaps with at least part of the at least one predetermined range of values.

5. The method of claim 3 wherein when acquiring a range of voxel values the step of determining a status of a value of at least one value type of the image data with respect to the at least one predetermined range of values for the value type further comprises determining whether at least a part of the range of voxel values overlaps with at least part of the at least one predetermined range of values.

6. The method of claim 3 wherein when acquiring a single voxel value the step of determining a status of a value of at least one value type of the image data with respect to the at least one predetermined range of values for the value type further comprises determining whether the single voxel value falls within at least part of the at least one predetermined range of values.

7. The method of claim 3 wherein when acquiring a single sample value the step of determining a status of a value of at least one value type of the image data with respect to the at least one predetermined range of values for the value type further comprises determining whether the single sample value falls within at least part of the at least one predetermined range of values.

8. The method of claim 1 wherein the step of deriving the at least one predetermined range of values from a classification function for the resulting image comprises deriving the at least one predetermined range of values from a classification function of opacity values for the resulting image.

9. The method of claim 1 wherein the at least one predetermined range of values comprises at least one predetermined range of valid values.

10. The method of claim 1 wherein the at least one predetermined range of values is derived from one of a plurality of classification functions.

11. The method of claim 1 wherein the at least one predetermined range of values is derived from a multi-dimensional classification function.

12. The method of claim 9 wherein defining the image data at least in part as a function of the status of the value of at least one value type of the image data with respect to the at least one predetermined range of valid values further comprises defining the image data as valid when the image data falls within the at least one predetermined range of valid values such that the image data is further processed toward providing the resulting image.

13. The method of claim 9 wherein defining the image data at least in part as a function of the status of the value of at least one value type of the image data with respect to the at least one predetermined range of valid values further comprises defining the image data as invalid when the image data falls outside of each of the at least one predetermined range of valid values for a given value type such that the image data is not further processed with respect to providing the resultant image.

14. A system for testing data used to provide a resulting image from a set of three dimensional data comprising:
an image data memory buffer circuit;
a classification function memory circuit; and
a comparator circuit operatively coupled to the image data memory buffer circuit and the classification function memory circuit to compare image data from the image data memory buffer to at least one given range of values determined from at least one classification function stored in the classification function memory circuit.

15. The system of claim 14 wherein the comparator circuit comprises at least one of the group comprising:
a field programmable gate array;
an application specific integrated circuit (“ASIC”) based chip; and
a digital signal processor (“DSP”) chip.

16. The system of claim 14 further comprising:
an interpolator circuit operatively coupled to the image data memory buffer circuit to provide interpolated sample values as image data for the image data memory buffer circuit.

17. The system of claim 14 further comprising:
an image rendering circuit operatively coupled to the comparator circuit to operate upon image data passing from the comparator circuit.

18. The system of claim 17 further comprising:
a resulting image buffer circuit coupled to the image rendering circuit to receive resulting image data; and
a display and a display circuit operatively coupled to the resulting image buffer circuit to display the resulting image.

19. The system of claim 17 wherein the image rendering circuit comprises an opacity classification circuit and a compositing circuit.

20. The system of claim 19 wherein the opacity classification circuit is integral with the classification function memory circuit.

21. The system of claim 17 wherein the image rendering circuit further comprises at least one of a group comprising:
a gradient calculation circuit; and
an illumination circuit.

22. An apparatus for classifying image data comprising:
means for accessing image data;
means for interpolating image data from the means for accessing image data, the means for interpolating further comprising means for providing at least one image sample value from the image data;
means for comparing the at least one image sample value from the means for providing the at least one image sample value to at least one given range of valid values to determine whether the at least one image sample value is valid; and
means for processing valid image sample values from the means for comparing as part of providing a resulting image.

23. The apparatus of claim 22 further comprising:
means for removing invalid image samples from the means for processing the valid image sample values wherein the means for removing invalid image samples is operatively coupled to the means for comparing.

24. The apparatus of claim 22 further comprising:
means for storing data corresponding to the resulting image operatively coupled to the means for processing.

25. The apparatus of claim 24 further comprising:
display means for displaying the resulting image operatively coupled to the means for storing.
